(19) United States
(12) Patent Application Publication
(10) Pub. No.: US 2026/0163438 A1
(43) Pub. Date: Jun. 11, 2026

(54) MOTOR

(71) Applicant: Toyota Jidosha Kabushiki Kaisha, Toyota-shi (JP)

(72) Inventors: Takanori ASAI, Toyota-shi (JP); Shogo Kajimoto, Toyota-shi (JP); Kengo Ohira, Toyota-shi (JP); Jun Kawakami, Nishio-shi (JP)

(73) Assignee: TOYOTA JIDOSHA KABUSHIKI KAISHA, Toyota-shi (JP)

(21) Appl. No.: 19/304,777

(22) Filed: Aug. 20, 2025

(30) Foreign Application Priority Data
Dec. 10, 2024 (JP) 2024-215416

(51) Int. Cl. H02K 5/18; H02K 5/20; H02K 9/19

(52) U.S. Cl. CPC H02K 5/18; H02K 5/203; H02K 9/19

(57) ABSTRACT

The motor has a case in which a rib is provided on an outer peripheral surface. The rib has a first portion and a second portion having a smaller amount of protrusion from the outer peripheral surface than the first portion. The first portion extends in a polygonal grid and the second portion is adjacent to the first portion and extends along the first portion. Since the rib provided in the case of the motor has the first portion having a large protrusion amount and the second portion having a small protrusion amount, heat can be efficiently dissipated from the case.

### CROSS-REFERENCE TO RELATED APPLICATION

This application claims priority to Japanese Patent Application No. 2024-215416 filed on Dec. 10, 2024. The disclosure of the above-identified application, including the specification, drawings, and claims, is incorporated by reference herein in its entirety.

### BACKGROUND

### 1. Technical Field

The technique disclosed in the present specification relates to a motor.

### 2. Description of Related Art

Japanese Unexamined Patent Application Publication No. 2023-28863 (JP 2023-28863 A) discloses a motor in which a rib is provided on a wall surface of a case. The rib extends in a hexagonal grid shape.

### SUMMARY

When the motor is operated, the entire motor generates heat. The heat generated by the motor is discharged to the outside via the case. The present specification proposes a technique for further improving the amount of heat to be released from the case.

An aspect of the present specification discloses a motor including a case provided with a rib on an outer peripheral surface. The rib includes a first portion and a second portion that protrudes from the outer peripheral surface by an amount that is less than the first portion. The first portion extends in a polygonal grid shape. The second portion is adjacent to the first portion and extends along the first portion.

Since the rib provided on the case of the motor includes a first portion having a larger protrusion amount and a second portion having a smaller protrusion amount, heat can be efficiently released from the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a motor;

FIG. 2 is a side view of the motor;

FIG. 3 is a III-III cross-sectional view of FIG. 2; and

FIG. 4 is a cross-sectional view of a motor according to a modification.

### DETAILED DESCRIPTION OF EMBODIMENTS

The motor may further include a cooling pipe housed in the case and configured to discharge a cooling liquid into the case. When viewed along the radial direction of the motor, the rib may be provided at a position overlapping with the cooling flow path.

“Radial direction” is a direction along the radius of a circle about the axis of rotation of the motor.

In this motor, a rib exists in the vicinity of the cooling pipe. Therefore, the temperature of the refrigerant flowing in the cooling pipe tends to decrease.

In the motor, the first portion may extend in a hexagonal lattice shape.

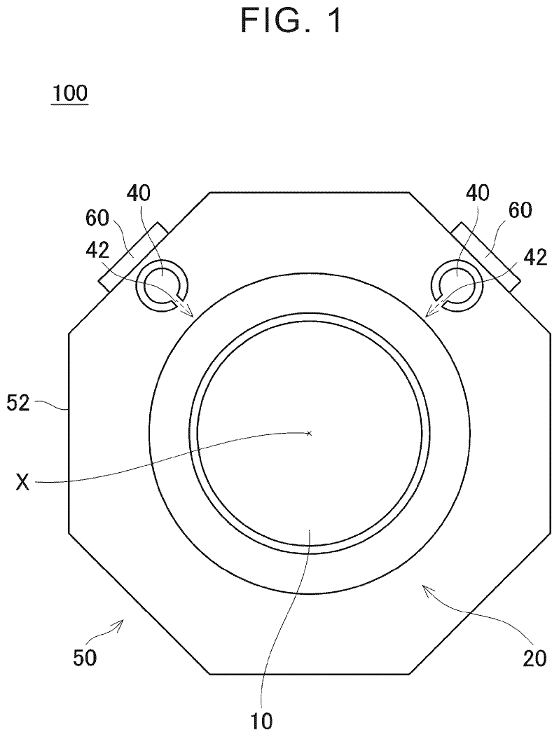

The motor 100 illustrated in FIG. 1 includes a rotor 10, a stator 20, and a case 50. The stator 20 has a cylindrical shape. The rotor 10 is disposed in the center hole of the stator 20 so that the center axis of the rotor 10 and the center axis of the stator 20 coincide with each other. The rotor 10 and the stator 20 are housed in the case 50. Hereinafter, a direction parallel to the rotation axis X of the motor 100 (that is, the center axis of the rotor 10) is referred to as an axial direction, a direction along a radius of a circle around the rotation axis X of the motor 100 is referred to as a radial direction, and a direction along a circle around the rotation axis X of the motor 100 is referred to as a circumferential direction.

The case 50 has an outer peripheral surface 52. The outer peripheral surface 52 has a polygonal cylindrical shape extending along the axial direction. A rib 60 is provided on the outer peripheral surface 52. The rib 60 is provided on the upper portion of the case 50. The rib 60 protrudes from the outer peripheral surface 52 toward the outside of the case 50.

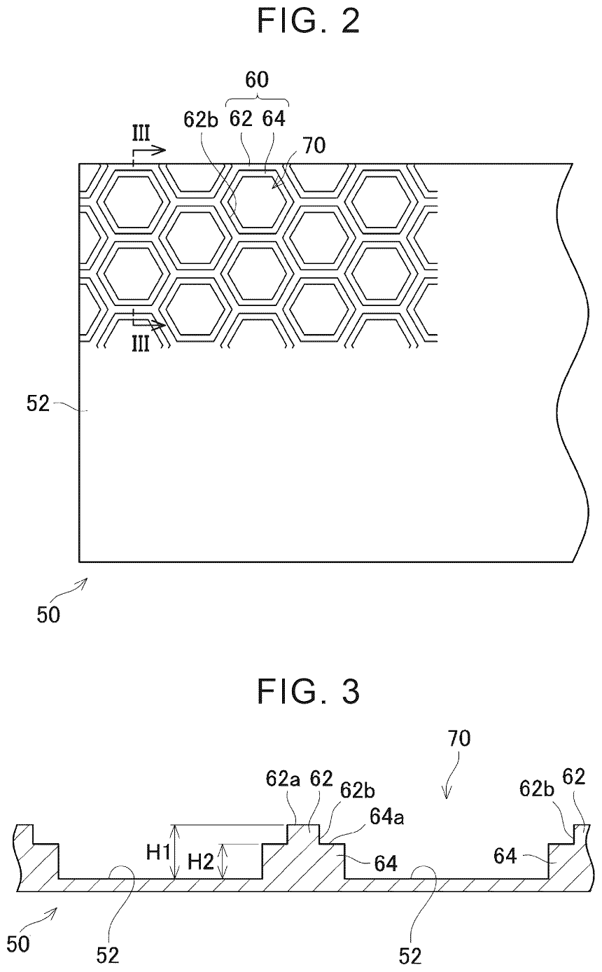

As shown in FIGS. 2 and 3, the rib 60 has a first portion 62 and a second portion 64. As shown in FIG. 3, the first portion 62 and the second portion 64 protrude from the outer peripheral surface 52 toward the outside of the case 50. The second portion 64 has a smaller protrusion amount from the outer peripheral surface 52 than the first portion 62. That is, the height H2 from the outer peripheral surface 52 to the distal end surface 64a of the second portion 64 is lower than the height H1 from the outer peripheral surface 52 to the distal end surface 62a of the first portion 62. The distal end surface 64a of the second portion 64 is disposed at a position closer to the outer peripheral surface 52 than the distal end surface 62a of the first portion 62. Therefore, in the rib 60, a step is formed by the first portion 62 and the second portion 64.

As shown in FIG. 2, the first portion 62 extends in a hexagonal lattice on the outer peripheral surface 52. In other words, the first portion 62 has a honeycomb structure. That is, the first portion 62 extends in a mesh shape so as to form a plurality of regular hexagons. Each side of each regular hexagon formed by the first portion 62 is shared with the side of another adjacent hexagon. Therefore, the first portion 62 has a structure in which a plurality of regular hexagonal ribs is arranged without gaps. A recess 70 is provided in the center of each regular hexagon formed by the first portion 62.

The second portion 64 is provided in the recess 70. The second portion 64 is disposed adjacently to the first portion 62 and extends along a side surface 62b of the first portion 62. The second portion 64 has a regular hexagonal shape extending along the first portion 62.

The motor 100 includes a cooling pipe 40. The cooling pipe 40 is housed in the case 50. The cooling pipe 40 is provided at a position overlapping with the rib 60 when viewed along the radial direction. The cooling pipe 40 is disposed at an upper portion of the stator 20 and away from the stator 20. The cooling pipe 40 extends along the axial direction. A refrigerant (for example, oil) supplied from the outside flows through the cooling pipe 40. The refrigerant discharge port 42 provided in the cooling pipe 40 discharges the refrigerant from the cooling pipe 40 toward the stator 20. Thus, the stator 20 is cooled.

During operation of the motor 100, the motor 100 generates heat. The heat generated by the motor 100 is discharged to the outside through the case 50. A rib 60 is provided on the outer peripheral surface 52 of the case 50. Therefore, the rib 60 discharges the heat generated by the motor 100 to the outside. As described above, since the rib 60 has the first portion 62 and the second portion 64, the amount of heat dissipated from the case 50 increases, and the motor 100 can be cooled efficiently.

During operation of the motor 100, the refrigerant flowing through the cooling pipe 40 is discharged from the refrigerant discharge port 42 toward the stator 20. The discharged refrigerant cools the stator 20. When viewed along the radial direction, the rib 60 is provided at a position overlapping with the cooling pipe 40. Therefore, the heat of the refrigerant flowing through the cooling pipe 40 is easily discharged to the outside via the rib 60. As a result, the temperature of the refrigerant flowing through the cooling pipe 40 decreases, and the motor 100 can be cooled more efficiently.

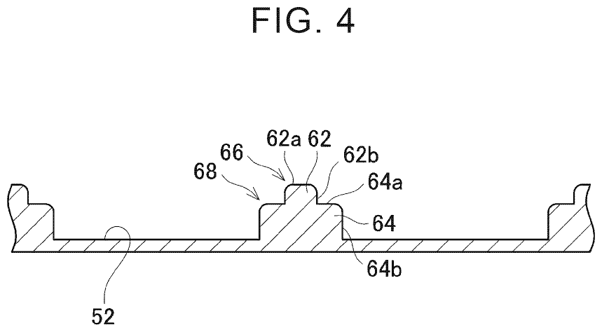

In the embodiment described above, as shown in FIG. 4, a chamfered portion 66 may be provided at a corner portion between the distal end surface 62a of the first portion 62 and the side surface 62b of the first portion 62. In addition, a chamfered portion 68 may be provided at a corner portion between the distal end surface 64a of the second portion 64 and the side surface 64b of the second portion 64. By providing the chamfered portions 66 and 68 in this manner, the motor 100 can be cooled more efficiently.

In the embodiments described above, the first portion 62 of the rib 60 has been extended to form a plurality of regular hexagons. However, the first portion 62 of the rib 60 may extend to form a plurality of polygons other than regular hexagons. That is, the first portion 62 of the rib 60 may extend in a polygonal grid.

Although the embodiments have been described in detail above, the embodiments are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or the drawings achieve a plurality of objectives at the same time, and achieving one of the objectives itself has technical usefulness.

What is claimed is:

1. A motor comprising a case provided with a rib on an outer peripheral surface, wherein:
the rib includes a first portion and a second portion that protrudes from the outer peripheral surface by an amount that is less than the first portion;
the first portion extends in a polygonal grid shape; and
the second portion is adjacent to the first portion and extends along the first portion.

2. The motor according to claim 1, further comprising a cooling pipe that is housed in the case and that discharges a cooling liquid into the case, wherein when viewed along a radial direction of the motor, the rib is provided at a position overlapping with the cooling pipe.

3. The motor according to claim 1, wherein the first portion extends in a hexagonal grid shape.
